(19) United States
(12) Patent Application Publication
(10) Pub. No.: US 2020/0005241 A1
(43) Pub. Date: Jan. 2, 2020

(54) SYSTEMS AND METHODS FOR A PROJECT PORTAL

(71) Applicant: Outbox Systems, Inc. dba Simplus, Sandy, UT (US)

(72) Inventor: Isaac Westwood, Draper, UT (US)

(21) Appl. No.: 16/175,222

(22) Filed: Oct. 30, 2018

Related U.S. Application Data
(60) Provisional application No. 62/692,017, filed on Jun. 29, 2018.

(51) Int. Cl. G06Q 10/10; G06Q 10/06

(52) U.S. Cl. CPC G06Q 10/103; G06Q 10/0635; G06Q 10/0637; G06Q 10/063114

(57) ABSTRACT

Systems and methods relating to a portal interface system, displayable on a computing device, the portal interface system communicating with data related to a project managed with a Customer Relationship Management (CRM) program, are disclosed. The portal interface system includes a protection component that controls access to the portal interface to only authorized users. The systems further include a link to at least one project page, the project page that includes at least one tab containing the data related to the project managed with a CRM program, and a metrics component display area that displays metrics component processed results of the data related to the project. The metrics component processed results include one or more of: a project done statement display, a project phase display, a project health display, a burn percentage display, a project hours display, a project budget display, a project tasks display, a project complete percentage display, a target go-live date display, and an end date display.

### CROSS-REFERENCE TO RELATED APPLICATIONS

This application, under 35 U.S.C. § 119, claims the benefit of U.S. Provisional Patent Application Ser. No. 62/692,017 filed on Jun. 29, 2018, and entitled “Systems and Methods for a Project Portal,” the contents of which are hereby incorporated by reference herein.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 2018, Simplus, All Rights Reserved.

### FIELD OF THE DISCLOSURE

This disclosure relates to systems and methods for displaying information related to ongoing projects. In particular, the disclosure relates to improved portals for computing devices to enable users to access project information.

### BACKGROUND

Cloud computing customer relationship management (CRM) products typically provide software, or software as a service (SaaS), tools that allow users to manage ongoing projects. As used herein a “project” is any individual or collaborative enterprise that is planned and designed to achieve a particular aim. Examples of projects include, but are not limited to, new product launches, managing sales to one or more customers, managing a group of salespersons, overseeing new building construction or renovations, developing new customer relationships, fundraising for a particular goal, software implementation, custom development, managed services, advisory services, change management, or the like. Often, CRM products provide one or more platforms for project management with functionalities such as task management, automatic routing and escalating of important events, social networking plugins that enable the user to interact on social networking websites, analytical tools, API and middleware integrations, email alerts, web searching, workflows, triggers, and other services and tools.

As will be understood by those of ordinary skill in the art, typical CRM products provide a wide array of information concerning particular projects. For example, CRM products often provide access to project documents, task lists, task owner lists, timelines, milestone events, project communications (e.g., emails), analytic data, billing data, billed hours, project completion percentages, forecast data, funds remaining, progress, status, issues, or the like. However, in existing CRM products project information may be located in diverse locations, may be hard to find, may be accessible only through traversing many menus or hyperlinks, may be unorganized, may not exist, may require separate communication platforms, middleware, API integrations, or the like. These, and other, drawbacks of existing systems and methods exist. Therefore, there is a need for, among other things, a portal that enables users to view their real-time project data, communicate with their project team, review project documentation, mitigate project issues or risks, and increase overall project success.

### SUMMARY

Accordingly, the disclosed systems and methods provide, among other things, a portal that enables users to view their real-time project data, communicate with their project team, review project documentation, mitigate project issues or risks, review financial and budget details, review and pay invoices, view reports, view charts, view progress, status, schedule, and increase overall project success.

Disclosed embodiments include a portal interface system, displayable on a computing device, the portal interface system communicating with data related to a project managed with a CRM program, the portal interface system including a protection component that controls access to the portal interface to only authorized users, a link to at least one project page, the project page further having at least one tab containing the data related to the project managed with a CRM program, and a metrics component display area that displays metrics component processed results of the data related to the project, and wherein the metrics component processed results include one or more of: a project done statement display, a project phase display, a project health display, a burn percentage display, a project hours display, a project budget display, a project tasks display, a project complete percentage display, a target go-live date display, and an end date display.

Disclosed embodiments also include a Kanban board component display area that displays Kanban component processed results of the data related to the project, and wherein the Kanban component processed results include one or more of: RAID (Risks, Actions, Issues and Decisions) log entries, project phases, project tasks, and project progress. In further disclosed embodiments, the Kanban component processed results comprise RAID log entries and the RAID log entries are grouped by status.

Disclosed embodiments also include a second link to a second project page, the second project page further including at least one tab containing the data related to the project managed with a CRM program, and a metrics component display area that displays metrics component processed results of the data related to the project, and wherein the metrics component processed results include one or more of: project planned hours, project consumed hours, and project hours remaining. In further disclosed embodiments, the system includes a report component display area that displays report component processed results of the data related to the project, and wherein the report component processed results include parent level tasks. In still further disclosed embodiments, the parent level tasks are summed by estimated and consumed hours.

Disclosed embodiments also include a Gantt component display area that displays Gantt component processed results of the data related to the project, and wherein the Gantt component processed results include parent level tasks ordered by start date.

Disclosed embodiments also include a Kanban board component display area that displays Kanban board component processed results of the data related to the project, and wherein the Kanban component processed results include project tasks grouped by status.

Disclosed embodiments also include a second link to a second project page, the second project page further including a chatter feed component display area that displays chatter feed component processed results, and wherein the chatter feed component processed results include one or more of: external and internal communication platforms.

Disclosed embodiments also include a second link to a second project page, the second project page further including a project details display area that displays fields associated with a project object. In further disclosed embodiments, the fields associated with a project object include links to a cloud-based storage repository.

Disclosed embodiments also include a second link to a second project page, the second project page further including a project documents display area that displays documents associated with a project. In further disclosed embodiments, the project documents display area is configured to enable uploading and downloading of the documents associated with a project.

Disclosed embodiments also include a second link to a second project page, the second project page further including a project team component display area that displays project team component processed results, and wherein the project team component processed results include one or more of: a project account executive, a project delivery manager, and a project manager. In still further disclosed embodiments, the project team component processed results further include a profile image.

Also disclosed are methods for displaying a portal interface system on a computing device, the portal interface system communicating with data related to a project managed with a CRM program, the method including controlling access to the portal interface system with a protection component that controls access to the portal interface to only authorized users, linking to at least one project page, the project page further including at least one tab containing the data related to the project managed with a CRM program, and a metrics component display area that displays metrics component processed results of the data related to the project, and wherein the metrics component processed results include one or more of: a project done statement display, a project phase display, a project health display, a burn percentage display, a project hours display, a project budget display, a project tasks display, a project complete percentage display, a target go-live date display, and an end date display.

Disclosed method embodiments include displaying a Kanban board component display area that displays Kanban component processed results of the data related to the project, and wherein the Kanban component processed results include one or more of: RAID log entries, project phases, project tasks, and project progress.

Disclosed method embodiments include linking to a second project page, the second project page further including at least one tab containing the data related to the project managed with a CRM program, and a metrics component display area that displays metrics component processed results of the data related to the project, and wherein the metrics component processed results include one or more of: project planned hours, project consumed hours, and project hours remaining.

Disclosed method embodiments also include displaying a report component display area that displays report component processed results of the data related to the project, and wherein the report component processed results include parent level tasks.

Disclosed method embodiments also include displaying a Gantt component display area that displays Gantt component processed results of the data related to the project, and wherein the Gantt component processed results include parent level tasks ordered by start date. Other advantages, features, efficiencies, and conveniences are also disclosed.

### BRIEF DESCRIPTION OF THE DRAWINGS

FIG. 1 is a schematic exemplary system architecture in accordance with disclosed embodiments.

FIG. 2 is an exemplary data schema in accordance with disclosed embodiments.

FIG. 3 is an exemplary illustration of a portal as viewed on a typical computing device in accordance with disclosed embodiments.

FIG. 4 is an exemplary illustration of a project records page as viewed on a typical computing device in accordance with disclosed embodiments.

FIGS. 5A-5B are an exemplary illustration of another tab of a project records page as viewed on a typical computing device in accordance with disclosed embodiments.

FIG. 6 is an exemplary illustration of another tab of a project records page as viewed on a typical computing device in accordance with disclosed embodiments.

FIGS. 7A-7B are an exemplary illustration of another tab of a project records page as viewed on a typical computing device in accordance with disclosed embodiments.

FIG. 8 is an exemplary illustration of another tab of a project records page as viewed on a typical computing device in accordance with disclosed embodiments.

FIG. 9 is an exemplary illustration of another tab of a project records page as viewed on a typical computing device in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

The disclosed embodiments provide a portal 100 tool specifically built to provide users a location to view their real-time project data, communicate with their project team, review documentation, mitigate issues and risks, and increase overall project success. As used herein, a “portal” is a user interface in communication over a network (such as the Internet) with remotely stored information (e.g., cloud based storage). As disclosed herein, the particular subsets of information and functionalities accessible through the portal 100 are designed to more efficiently and conveniently display information helpful to project management.

As will be apparent to those of skill in the art having the benefit of this disclosure, the portal 100 may be displayable on any computing device suitable for displaying hyper text markup language (HTML) readable displays. Some embodiments may include cascading style sheets (CSS) type displays. Other programming languages and display types may also be used.

Embodiments of the portal 100 are built with a CRM product, such as the Salesforce Community Cloud platform, which is a part of the Salesforce Lightning architecture. Community Cloud is a tool specifically intended to surface data from Salesforce into a user-facing portal 100. Embodiments of the data driving the portal 100 come from the FinancialForce managed package, which can be used to manage projects, resources and timecards.

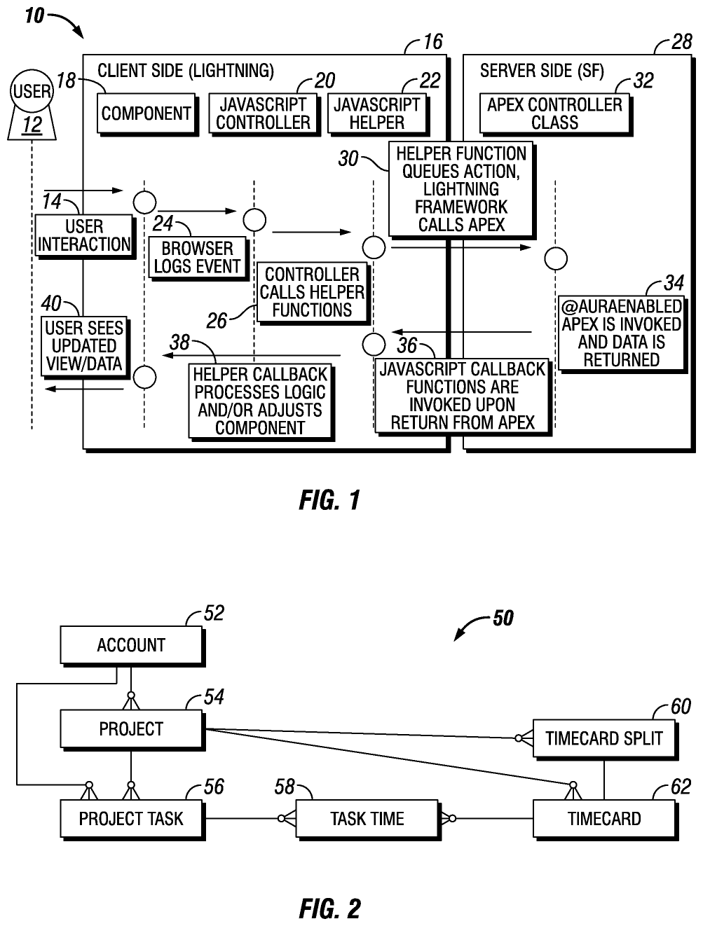

FIG. 1 is a schematic exemplary system 10 architecture in accordance with disclosed embodiments. As shown, a user 12 interacts (as indicated at 14) with a client-side computing device 16. As used herein, “computing device” refers to any kind of processor-based device that can process and display information. For example, computing devices can include, but are not limited to, personal computers (PCs), laptop computers, tablet devices, mobile telephones, personal digital assistants (PDAs), and the like.

Client-side device 16 is configured to read and process various program information and display accordingly on the portal 100. For example, in object-oriented program languages (e.g., Java) a number of components 18 may be displayed on the client-side device 16 screen and enable the user 12 to interact (as indicated at 14) with the component 18 (e.g., by selecting a tab, check box, radio button, scrollbar, entering text, or the like). As indicated at 24, the user's 12 browser logs the user's 12 interaction and, in cooperation with controller 20 and helper 22, calls the desired helper functions as indicated at 26.

Communication then passes to server side device 28 as indicated at 30 where the helper function queues the appropriate action(s), and the framework (e.g., Lightning Framework) calls the appropriate server 28 controllers 32. Server 28 controllers 32 may be any of standard controllers that are provided by the platform and contain built-in functionality, extension controllers built to add functionality to a display using a different controller, and standalone controllers that are completely customized for a display or set of displays. In a CRM product such as Salesforce, server 28 controllers 32 are typically Apex Controllers.

As indicated at 34, upon the server 28 controllers 32 being invoked, data corresponding to the user interaction 14 is retrieved and returned. Upon the return of the data callback functions 36 (e.g., Javascript callback functions) are invoked and the data is communicated back to client side device 16. As indicated at 38, helper 22 callback processes the data and/or adjusts the component 18 accordingly and, as indicated at 40, the user 12 is displayed the updated view or data returned from server side device 28.

As discussed above, embodiments of the disclosed systems and methods may be implemented on a CRM product such as the Salesforce Community Cloud which is built on the Lightning Framework. Typically, Lightning encompasses an application and user interface layer. Lightning is primarily a client side device 16 framework, allowing for customization of the user interface layer. As discussed, Lightning allows for components 18 that can be configured in a reusable fashion. Components 16 can interact with (e.g., read, edit, create and delete records) the Salesforce database on server side device 28, take input from users 12, and interact with each other. Data Manipulation Language (DML) operations can be handled by server 28 controllers 32 (e.g., Apex controllers), or through a service such as Lightning DataService.

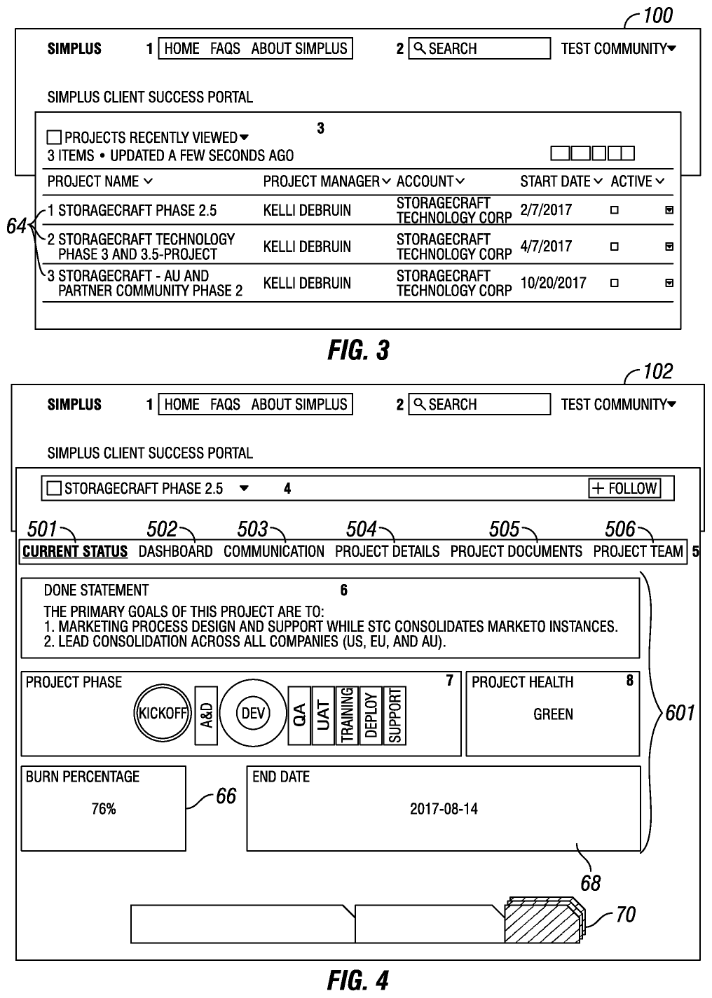

FIG. 2 is an exemplary data schema 50 in accordance with disclosed embodiments. As disclosed herein, data displayed in the portal 100 on client side device 16 may come from a CRM product that includes Professional Services Automation (PSA) software to provide Enterprise Resource Planning (ERP) tools. Embodiments of the portal 100 may focus on project tasks and timecards for data to display to user 12. As indicated in FIG. 2, embodiments of data schema 50 include account 52, project 54, project task 56, task time 58, timecard split 60, and timecard 62. Embodiments of the portal 100 have the one-to-one, one-to-many, and many-to-many relationships as indicated on FIG. 2.

For embodiments of the portal 100, users 12 begin as contacts within the CRM product database (e.g., on server side device 28). These contacts are associated to accounts 52, which are associated to projects 54. When it is determined that a new portal 100 user is to be provisioned, a user 12 interaction 14 with the contact record (e.g., a button on the contact record is clicked, or the like) creates a new user record tied to the contact.

Portal 100 users may have various degrees of access to standard and custom objects. For example, users 12 may have visibility to standard and custom objects, but not have greater levels of access, such as the ability to run reports, manage users, be members of public groups, etc. Other levels of access are also possible. For example, a custom user 12 profile may be created for portal 100 users. A custom profile gives the user 12 access to specific fields on the project 54, account 52, contact, timecard 62, RAID log (risks, actions, issues, and decisions log), and user objects. A breakdown of embodiments of field visibility is provided in the Tables 1-6 below.

TABLE 1
Account 52 Object

| Field Name | Field Type | Read Access |
|---|---|---|
| Account Name | Name | Y |
| Account Owner | Lookup | Y |
| Account Primary Contact | Lookup | Y |
| Account Record Type | Record Type | Y |
| Billing Address | Address | Y |
| Customer Portal Account | Checkbox | Y |
| Industry | Picklist | Y |
| Legal Name | Text | Y |
| Phone | Phone | Y |
| Postal Code | Lookup | Y |
| Website | URL | Y |

TABLE 2
Contact Object

| Field Name | Field Type | Read Access |
|---|---|---|
| Account Name | Lookup | Y |
| Alt email | Email | Y |
| Assistant | Text | Y |
| Asst. Phone | Phone | Y |
| Contact Owner | Lookup | Y |
| Contact Record Type | Record Type | Y |
| Department | Text | Y |
| Email | Email | Y |
| Home Phone | Phone | Y |
| LinkeIn Profile | URL | Y |
| Mailing Address | Address | Y |
| Name | Name | Y |
| Phone | Phone | Y |
| CRM user | Lookup | Y |
| Twitter handle | Text | Y |
| Type | Picklist | Y |

TABLE 3
Project 54 Object

| Field Name | Field Type | Read Access |
|---|---|---|
| % Complete | Percent | Y |
| Account | Lookup | Y |
| Bad Debt | Currency | Y |
| Billable Hours (internal) | Number | Y |
| Burn Percentage | Percent | Y |
| Currency | Picklist | Y |
| Done Statement | Long Text Area | Y |
| End Date | Date | Y |
| Formatted Go-Live Date | Text | Y |
| GDrive Folder | URL | Y |
| GO-Live Date | Date | Y |
| JIRA Project | URL | Y |
| Master Project | Lookup | Y |
| Opportunity Owner | Lookup | Y |
| Opportunity Sold By | Text | Y |
| Original End Date | Date | Y |
| Owner | Lookup | Y |
| Planned Hours | Number | Y |
| Planned Hours Remaining | Number | Y |
| Project Health | Picklist | Y |
| Project Lead | Lookup | Y |
| Project Manager | Lookup | Y |
| Project Manager User | Lookup | Y |
| Project Name | Text | Y |
| Project Phase | Picklist | Y |
| Project Status | Picklist | Y |
| Project Type | Picklist | Y |
| Record Type | Record Type | Y |
| Simplus Account Owner | Text | Y |
| Stage | Picklist | Y |
| Start Date | Date | Y |
| Total Assigned Hours | Number | Y |

TABLE 4
Project Task 56 Object

| Field Name | Field Type | Read Access |
|---|---|---|
| Completed | Checkbox | Y |
| End Date | Date | Y |
| Estimated Hours | Number | Y |
| External ID | Text | Y |
| Hours Remaining | Number | Y |
| Owner | Lookup | Y |
| Parent Task | Lookup | Y |
| Parent Task End Date | Date | Y |
| Parent Task Start Date | Date | Y |
| Percent Complete (hours) | Percent | Y |
| Priority | Picklist | Y |
| Project | Lookup | Y |
| Project Manager | Text | Y |
| Project Task Name | Text | Y |
| Start Date | Date | Y |
| Status | Picklist | Y |
| Timecard Hours | Number | Y |
| Top-Level Parent Task | Lookup | Y |

TABLE 5
Task Time 58 Object

| Field Name | Field Type | Read Access |
|---|---|---|
| Currency | Picklist | Y |
| External ID | Text | Y |
| Project Task | Lookup | Y |
| Resource | Text | Y |
| Task Time Number | Auto-Number | Y |
| Timecard | Lookup | Y |

TABLE 6
Timecard 62 Object

| Field Name | Field Type | Read Access |
|---|---|---|
| End Date | Date | Y |
| External ID | Text | Y |
| Owner | Lookup | Y |
| Project | Lookup | Y |
| Project ID | Text | Y |
| Project Task Hours | Number | Y |
| Resource | Lookup | Y |
| Start Date | Date | Y |
| Status | Picklist | Y |
| Submitted | Checkbox | Y |
| Timecard ID | Auto-Number | Y |

Embodiments of the portal 100 may rely on a ‘Private’ sharing model for accounts 52 and projects 54. A community sharing rule allows sharing projects 54 with users 12 based on their account 52. For example, if a provisioned portal 100 user 12 is a member of an account 52, they will be able to see all projects 54 associated with that account 54. All other projects and accounts are not visible to portal 100 users. This sharing model prevents users 12 from seeing other user 12 names, viewing project details, seeing documentation associated with other users 12, etc.

Many other objects inherit their visibility from their parent object. For example, users 12 cannot see contacts associated to another account 52. Tasks 56, timecards 62 and RAID log entries are all children of projects 54, and are only visible to users 12 with access to the project 54. Other visibility configurations are also possible.

Additional security comes from the ability to de-provision users 12 with a single interaction 14 (e.g., as single click on a checkbox, or the like). As a project 54 ends, or if a client contact leaves a project 54, they can be de-provisioned which removes their ability to log into the portal 100, or otherwise restricts their access.

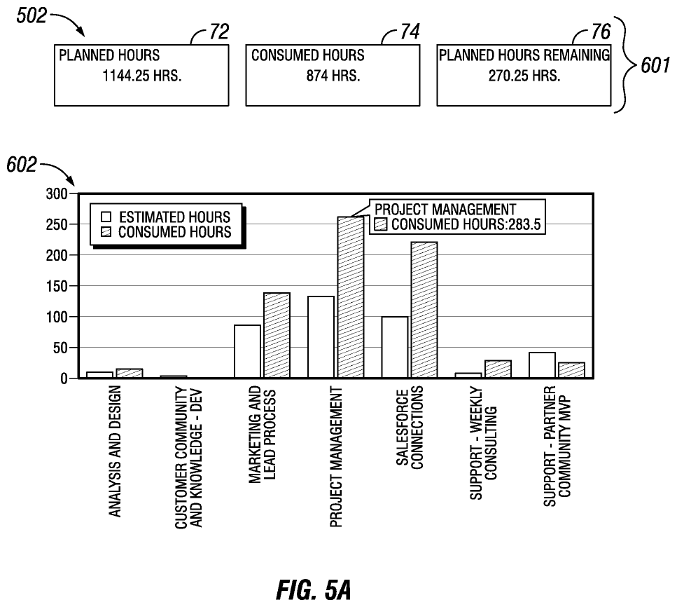

FIG. 3 is an exemplary illustration of a portal 100 as viewed on a typical computing device 16 in accordance with disclosed embodiments. As indicated, embodiments of portal 100 include a top-level navigation bar 1, a search box 2, and a records view window 3. Of course, other styles, designs, and locations for the navigation bar 1, search box 2, and records view window 3 may be implemented. As also indicated, within records view window 3, a number of links 64 to project records pages 102 are provided. Other information, such as project manager, account 52, account date, status, or the like, may be displayed as desired.

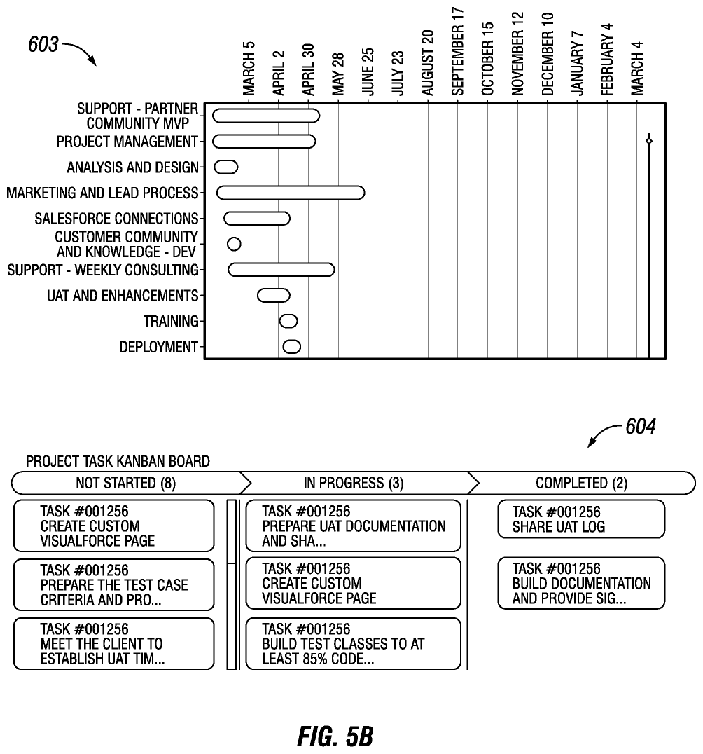

FIG. 4 is an exemplary illustration of a top portion of a project records page 102 as viewed on a typical computing device 16 in accordance with disclosed embodiments. Selecting a linked project record page 64 in record view window 3 will open the corresponding project records page 102. As indicated, embodiments of project records page 102 include a record header area 4 that displays the name of the project 54, a tab interface 5, and any custom Metric Components 601.

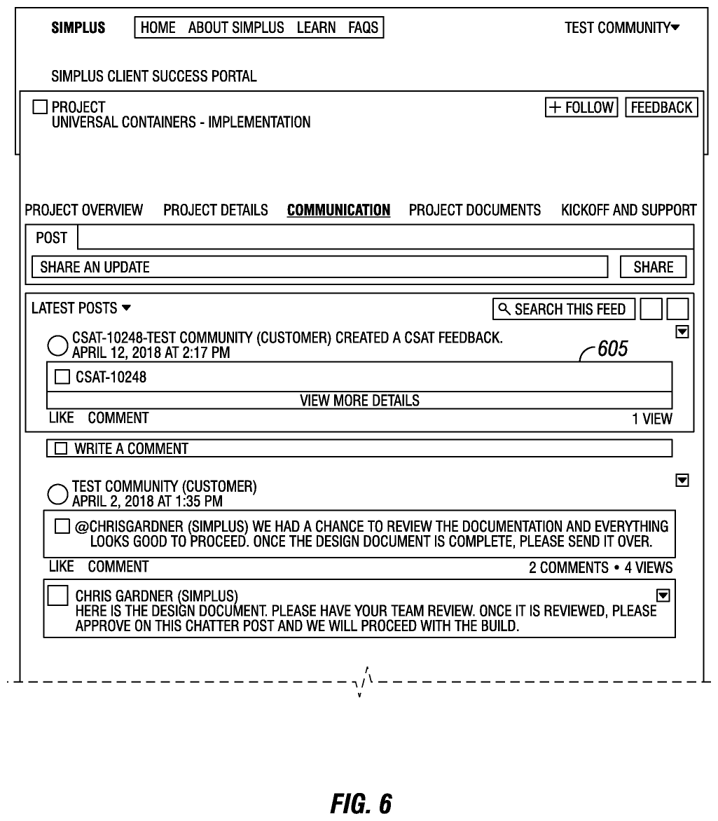

Embodiments of tab interface 5 include one or more tabs (501-506) that break out different pieces of a project 54. FIGS. 4-9 illustrate six exemplary tabs (501-506) as discussed herein. Embodiments of current status tab 501 (shown on FIGS. 4-5) feature three iterations of a metric component 601 (e.g., a component 18) which presents a project 54 Done Statement 6, Project Phase 7 and Project Health 8, finished with (FIG. 5) the Burn Percentage 66 and End Date 68 components 18.

FIG. 4 also shows a bottom portion of a project records page 102 as viewed on a typical computing device 16 in accordance with disclosed embodiments. As shown, below the metric component 601 is a Kanban board 70 showing RAID (Risks, Actions, Issues and Decisions) log entries. These entries identify potential risks, project issues, required decisions and actions performed on the project 54. These RAID log entries are grouped by status in FIG. 4 to allow the users 12 to track the progress of the entries through to resolution. In general, the current status tab 501 is intended to give a quick snapshot of a project's 54 current actionable items and health. This tab 501 can be used by stakeholders to gauge the project 54 status and health.

FIGS. 5A-5B are an exemplary illustration of another tab, a dashboard tab 502, of a project records page 102 as viewed on a typical computing device 16 in accordance with disclosed embodiments. Embodiments of dashboard tab 502 features one iteration of the metric component 601 to present the overall project 54 Planned Hours 72, Consumed Hours 74, and Hours Remaining 76. Below the metric component 601, the Report Component 602 shows the parent level tasks 56, summed by estimated and consumed hours.

Below this is the Gantt Component 603 which shows the parent level tasks 56, ordered by start date. These fit on the timeline for users 12 to understand the phases over time, and dependencies that could be affected by delays or changes to the project 54 schedule. Finally, a Kanban board 604 shows all project tasks 56 grouped by status. The users 12 can monitor these tasks 56 as they progress from planning to completion. Of course, different layouts and arrangements are also possible.

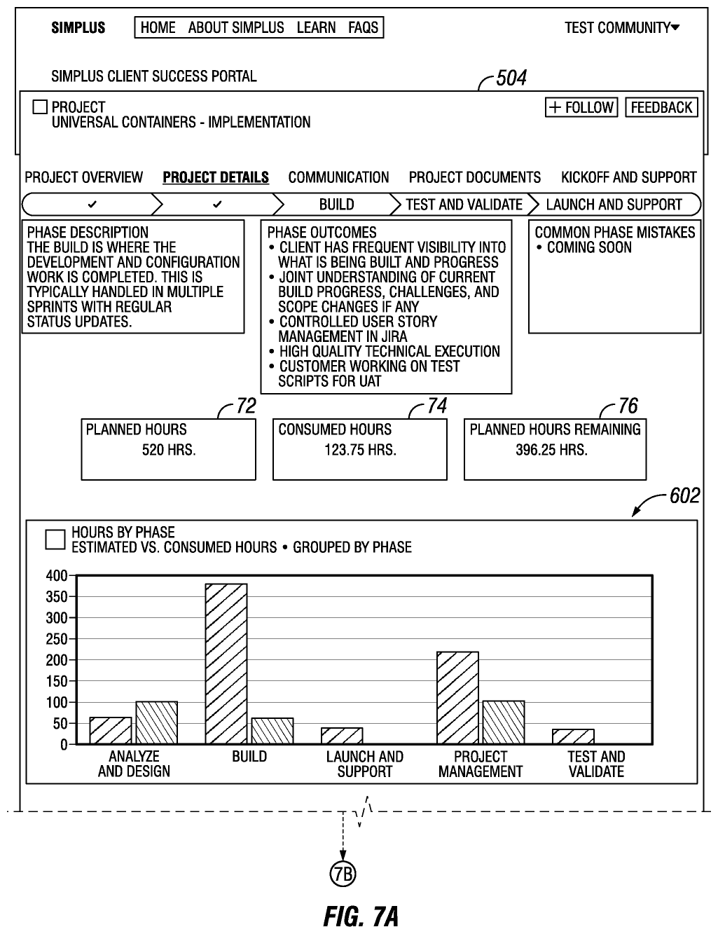

FIG. 6 is an exemplary illustration of another tab, the Communications tab 503, of a project records page 102 as viewed on a typical computing device 16 in accordance with disclosed embodiments. Communications tab 503 houses the Chatter Feed 605 component. This allows the users 12 to have a stream of communication, housed directly on the project 54. The Chatter Feed 605 can house both external and internal communication, with the internal communication not visible to some users 12 as desired.

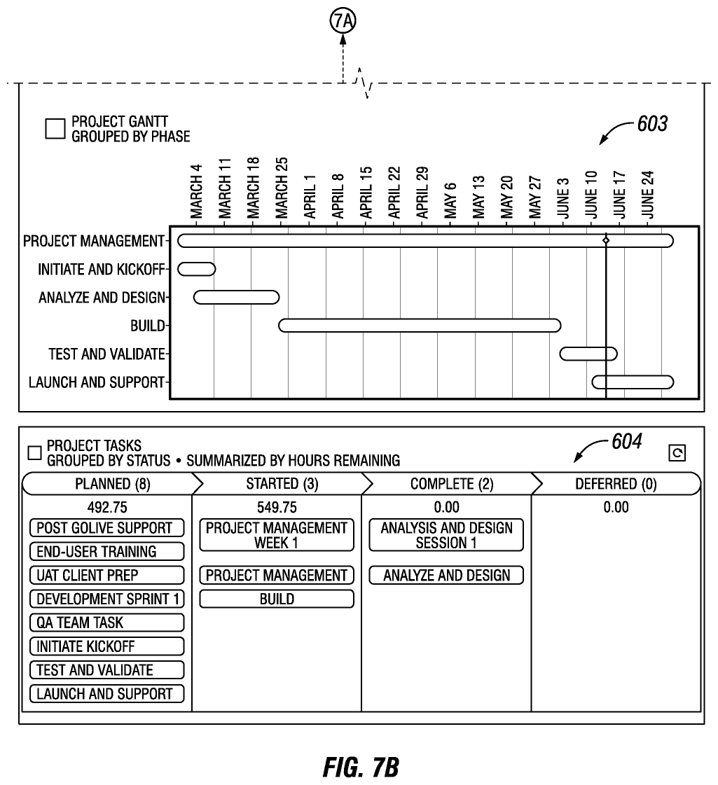

FIGS. 7A-7B are exemplary illustrations of another tab, the Project Details tab 504, of a project records page 102 as viewed on a typical computing device 16 in accordance with disclosed embodiments. Project Details tab 504 shows all fields that the user 12 can see on the project 54 object. This houses fields like links to the client's JIRA project or Google Drive folder, as well as other fields not shown in the components.

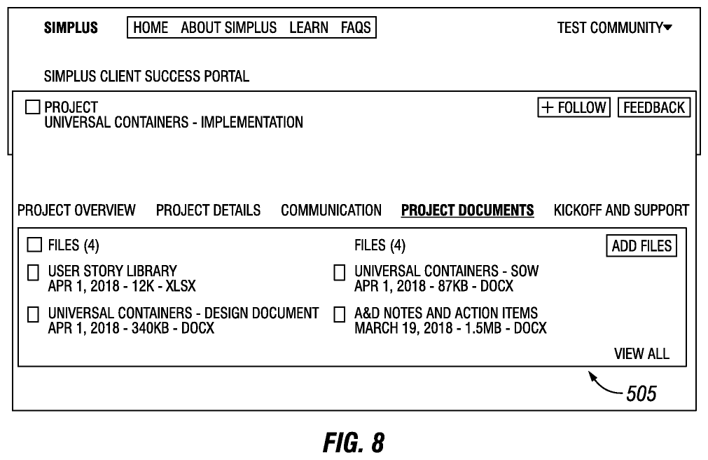

FIG. 8 is an exemplary illustration of another tab, the Project Documents tab 505, of a project records page 102 as viewed on a typical computing device 16 in accordance with disclosed embodiments. Project Documents tab 505 houses documents attached to the project 54. This may include, but is not limited to, the countersigned statement of work (SOW), the design documents, and any other relevant documentation that the user 12 may need to access.

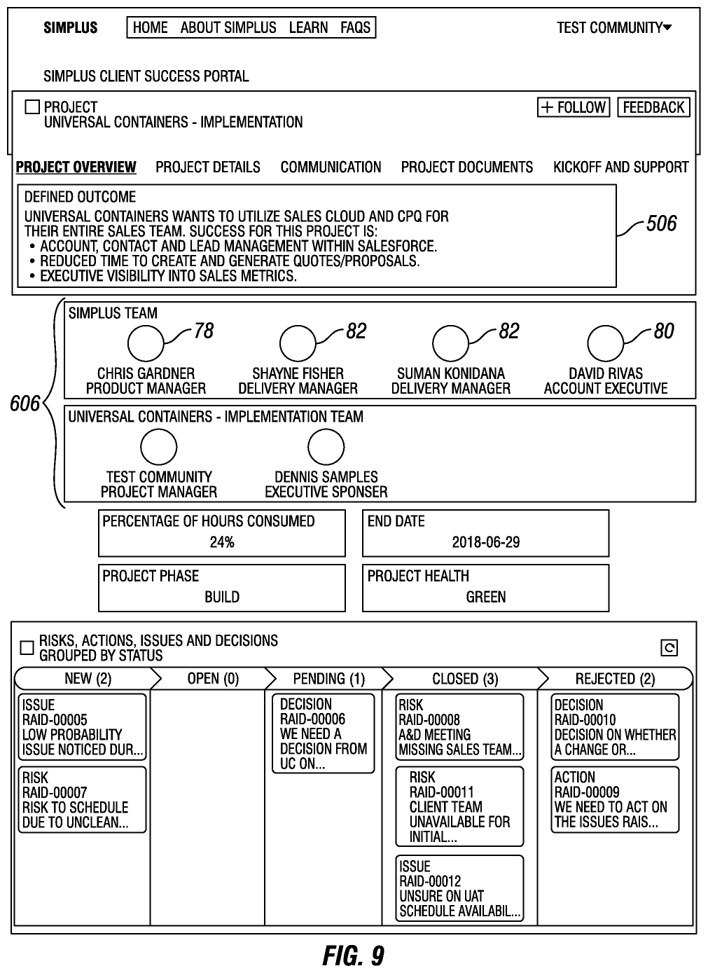

FIG. 9 is an exemplary illustration of another tab, the Project Team tab 506, of a project records page 102 as viewed on a typical computing device 16 in accordance with disclosed embodiments. Project Team tab 506 shows the user 12 their Simplus account executive 80, the delivery manager(s) 82, and their project manager 78. The Project Team 606 component grabs the user's profile image, title, and bio to provide a more personal touch to the community. Of course, other team members and other information may also be displayed.

Embodiments of system 10 may also include other components 18. For example, a project 54 snapshot report component 18 may be included and comprise a weekly, or other selectable timeframe, exportable report that gathers the FinancialForce data that is in the portal. Using a pre-built template (e.g., built with a contract lifecycle management tool Conga), the project 54 data is merged into a document. That data provides a historical snapshot of the project metrics at the moment it was generated.

Another component 18 may include a cross sell/upsell feature that is a custom Lightning component with logic to display additional services based on the current project 54. An example of this logic is:

IF (pse_Project_Type_c == ‘Implementation’ &&

pse_Project_Phase_c == ‘Test & Validate’) {

Ad_ Display_c = [‘CustomTraining’,’ManagedServices' ]

}

This allows for specifically targeted content to be shown to the client based on their potential needs. At a specific phase of a certain type of project 54, the client may be thinking about their training or maintenance needs. System 10 displays those related services during that phase.

Another component 18 may be a Net Promoter Score (NPS) collection feature. To gauge client satisfaction during a project 54, a custom Lightning component allows users to answer a set of questions geared to understand their likelihood to recommend system 10. This data is written to the CSAT_Feedback_c object in Salesforce, where it can be used for advanced reporting. The captured data can be combined with project type, project size, client industry, client size and other data to gain an understanding of strengths and areas for improvement.

Additional detail of various components 18, controllers 20, 32, and helpers 22 are provided below.

### Metric Component 601

The Metric Component 601 uses an Apex controller 32 to query data from the project object. The fields it queries are: End Date, Planned Hours, Planned Hours Remaining, Billable Hours, Burn Percentage, Project Health, Project Phase, Project Stage, Start Date, Defined Outcome Statement.

The metric component 601 has a configuration attribute for the layout, which determine how many metrics are shown. The layout options are ¼-¼-¼-¼, ⅓-⅓-⅓, ⅔-⅓, ⅓-⅔, and 1/1 (full width). Additional configuration attributes exist to allow the user 12 to choose which fields will display within the layout. Up to 4 fields are available.

Multiple iterations of this component 601 exist on the page 102, and the configurable nature allows for easy customization and adaptation of the component 601. The styling is customized to create an outlined box around each metric, provide a descriptive title, show a tooltip and draw attention to the text within the box.

The apex controller 32 queries the following fields: Billable Hours (Internal), Planned Hours, Planned Hours Remaining, Burn Percentage, End Date, Go Live Date, Start Date, Project Phase, Project Health, and Done Statement.

Exemplary coding for this controller 32 is as follows:

public with sharing class projectcontroller {

@AuraEnabled
public static List<pse_Proj_c> getProjectData(Id projectId) {

list<pse_Proj_c> 1stProj = [SELECT Id, Name, pse_Billable_Internal_Hours_c,

Burn_Percentage_c,

pse_End_Date_c, Go_Live_Date_c, pse_Planned_Hours_c,

Planned_Hours_Remaining_c,

Project_Health_c, pse_Project_Phase_c, pse_Stage_c,

pse_Start_Date_c, Done_Statement_c

FROM pse_Proj_c WHERE Id=:projectId];

return 1stProj;

}

}

Component Controller Code
({

doInit: function(cmp){
var action = cmp.get(“c.getProjectData”);
action.setParams({

“projectId”: cmp.get(“v.recordId”)

});

action.setCallback(this, function(response){

var state = response.getState( );
if (state === “SUCCESS”) {

cmp.set(“v.proj”, response.getReturnValue( ));

}
});
$A.enqueueAction(action);
}

})

Exemplary coding for metric component 601 controller 20 style is as follows:

Component Controller Style
.THIS .slds-card {

padding:10px;
text-align:center;

}
.THIS .slds-card h2 {

font-size:0.95rem;
font-weight:400;
text-align:left;

}
.THIS .slds-card span {

font-size:5.5rem;
color:#0099de;
font-weight:300;

}
.THIS .slds-card p {

font-size:1.25rem;
font-weight:300;
padding:18px 30px;
color:#666;

}
.THIS .slds-card span.Green {

color:#34a839;

}
.THIS .slds-card span.Yellow {

color:#e5e244;

}
.THIS .slds-card span.Red {

color:#c93522;

}
.THIS sup {

font-size: 55%;

}
.THIS sub {

font-size: 25%;
padding-left:5px;
bottom:0px;

}
.THIS .clearFloats:before, .THIS .clearFloats:after
{

content: “ ”;
display: table !important;

}
.THIS .clearFloats:after {clear: both;}
.THIS .clearFloats {*zoom: 1; }
.THIS .container .slice , .THIS .container.p50plus .slice
{

clip: rect[auto, auto, auto, auto);

}
.THIS .pie, .THIS .container .bar , .THIS .fill, .THIS .container.p50plus .fill{

position: absolute;

border: 0.08em solid #307bbb;
width: 0.84em;
height: 0.84em;
clip: rect[0em, 0.5em, 1em, 0em);
-webkit-border-radius: 50%;
-moz-border-radius: 50%;
-ms-border-radius: 50%;
-o-border-radius: 50%;
border-radius: 50%;
-webkit-transform: rotate(0deg);
-moz-transform: rotate(0deg);
-ms-transform: rotate(0deg);
-o-transform: rotate(0deg);
transform: rotate(0deg);

}
.THIS .pie-fill, .THIS .container.p50plus .bar:after, .THIS .container.p50plus .fill{

-webkit-transform: rotate(180deg);
-moz-transform: rotate(180deg);
-ms-transform: rotate(180deg);
-o-transform: rotate(180deg);
transform: rotate(180deg);

}
.THIS .container {

position: relative;
font-size: 120px;
width: 1em;
height: 1em;
-webkit-border-radius: 50%;
-moz-border-radius: 50%;
-ms-border-radius: 50%;
-o-border-radius: 50%;
border-radius: 50%;
float: left;
margin: 0 0.1em 0.1em 0;
background-color: #cccccc;

}
.THIS .container *, .THIS .container *:before, .THIS .container *:after {

-webkit-box-sizing: content-box;
-moz-box-sizing: content-box;
box-sizing: content-box;

}
.THIS .container.center {

float: none;
margin: 0 auto;

}
.THIS .container.big {

font-size: 240px;

}
.THIS .container.small {

font-size: 80px;

}
.THIS .container.medium {

font-size: 160px;

}
.THIS .container > span {

position: absolute;
width: 100%;
z-index: 1;
left: 0;
top: 0;
width: 5em;
line-height: 5em;
font-size: 0.2em;
color: #cccccc;
display: block;
text-align: center;
white-space: nowrap;
-webkit-transition-property: all;
-moz-transition-property: all;
-o-transition-property: all;
transition-property: all;
-webkit-transition-duration: 0.2s;
-moz-transition-duration: 0.2s;
-o-transition-duration: 0.2s;
transition-duration: 0.2s;
-webkit-transition-timing-function: ease-out;
-moz-transition-timing-function: ease-out;
-o-transition-timing-function: ease-out;
transition-timing-function: ease-out;

}
.THIS .container:after {

position: absolute;
top: 0.08em;
left: 0.08em;
display: block;
content: “ ”;
-webkit-border-radius: 50%;
-moz-border-radius: 50%;
-ms-border-radius: 50%;
-o-border-radius: 50%;
border-radius: 50%;
background-color: whitesmoke;
width: 0.84em;
height: 0.84em;
-webkit-transition-property: all;
-moz-transition-property: all;
-o-transition-property: all;
transition-property: all;
-webkit-transition-duration: 0.2s;
-moz-transition-duration: 0.2s;
-o-transition-duration: 0.2s;
transition-duration: 0.2s;
-webkit-transition-timing-function: ease-in
-moz-transition-timing-function: ease-in;
-o-transition-timing-function: ease-in;
transition-timing-function: ease-in;

}
.THIS .container .slice {

position: absolute;
width: 1em;
height: 1em;
clip: rect[0em, 1em, 1em, 0.5em);

}
.THIS .container:hover {

cursor: default;

}
.THIS .container:hover > span {

width: 3.33em;
line-height: 3.33em;
font-size: 0.3em;

}
.THIS .container:hover:after {

top: 0.04em;
left: 0.04em;
width: 0.92em;
height: 0.92em;

}
.THIS .container.blue .bar, .THIS .container.blue .fill {

border-color: #307bbb !important;

}
.THIS .container.blue:hover > span {

color: #307bbb;

}
.THIS .container.green .bar, .THIS .container.green .fill {

border-color: #4db53c !important;

}
.THIS .container.green:hover > span {

color: #4db53c;

}
.THIS .container.orange .bar, .THIS .container.orange .fill {

border-color: #dd9d22 !important;

}
.THIS .container.orange:hover > span {

color: #dd9d22;

}
.THIS .container.red .bar, .THIS .container.red .fill {

border-color: #ff0000 !important;

}
.THIS .container.red:hover > span {

color: #ff0000;

}
.THIS.legend{

color: rgb(22, 50, 92);
font-weight: bold;

}
.THIS.legend.big{

font-size: 1.25rem;
color: rgb(22, 50, 92);

}
.THIS.legend.medium{

font-size: 1.0rem;
color: rgb(22, 50, 92);

}
.THIS.legend.small{

font-size: 0.7 rem;
color: rgb(22, 50, 92);

}
.THIS .slds-card .slds-form-element {

position: absolute;
bottom: 10px;
right: 10px;

}
.THIS .phase { position:relative; float:left; }
.THIS .phaseBlock { padding:15px 10px; background:#d4d5da; color:#333;
transform:rotate(−90deg); width:90px; text-align:center; margin:0px −19px; }
.THIS .phaseBlock h4 { margin:0px; padding:0px; }
.THIS .phaseKickoff { width:80px; height:80px; border-radius:100px; border:5px solid #999999;
box-sizing:border-box; margin:−16px 2px 0px; text-align:center; line-height:69px; }
.THIS .phaseDev { width:150px; height:150px; border-radius:100px; border:40px solid #d4d5da;
margin:−55px 2px 0px; box-sizing:border-box; text-align:center; line-height:69px; }
.THIS .phaseAD { background:#d24835; color:#fff; }
.THIS .Kickoff .phaseKickoff { border-color:#d24835; }
.THIS .Kickoff .phaseAD { background:#d4d5da; color:#fff; }
.THIS .Development .phaseAD { background:#768f87; color:#fff; }
.THIS .Development .phaseDev { border-color:#d24835; }
.THIS .QA .phaseAD { background:#768f87; color:#fff; }
.THIS .QA .phaseDev { border-color:#768f87; }
.THIS .QA .phaseQA { background:#d24835; color:#fff; }
.THIS .UAT .phaseAD { background:#768f87; color:#fff; }
.THIS .UAT .phaseDev { border-color:#768f87; }
.THIS .UAT .phaseQA { background:#768f87; color:#fff; }
.THIS .UAT .phaseUAT { background:#d24835; color:#fff; }
.THIS .Training .phaseAD { background:#768f87; color:#fff; }
.THIS .Training .phaseDev { border-color:#768f87; }
.THIS .Training .phaseQA { background:#768f87; color:#fff; }
.THIS .Training .phaseUAT { background:#768f87; color:#fff; }
.THIS .Training .phaseTraining { background:#d24835; color:#fff; }
.THIS .GoLive .phaseAD { background:#768f87; color:#fff; }
.THIS .GoLive .phaseDev { border-color:#768f87; }
.THIS .GoLive .phaseQA { background:#768f87; color:#fff; }
.THIS .GoLive .phaseUAT { background:#768f87; color:#fff; }
.THIS .GoLive .phaseTraining { background:#768f87; color:#fff; }
.THIS .GoLive .phaseDeploy { background:#d24835; color:#fff; }
.THIS .Post .phaseDeploy { background:#768f87; color:#fff; }
.THIS .Post .phaseSupport { background:#d24835; color:#fff; }

Exemplary coding for metric component 601 controller 20 design is as follows:

Component Controller Design

```
<design:component label=“Metric Component”>
        <design:attribute name=“compLayout” label=“Layout”
datasource=“1/3-1/3-1/3,2/3-1/3,1/3-2/3,1/4-1/4-1/4-1/4,1/1” />
        <design:attribute name=“projField” label=“Project Field #1” datasource=“Billable
Hours,Burn Percentage,End Date,Planned Hours,Planned Hours Remaining,Project Health,Project
Phase,Project Stage,Start Date,Done Statement” />
        <design:attribute name=“projField2” label=“Project Field #2” datasource=“Billable
Hours,Burn Percentage,End Date,Planned Hours,Planned Hours Remaining,Project Health,Project
Phase,Project Stage,Start Date,Done Statement” />
        <design:attribute name=“projField3” label=“Project Field #3” datasource=“Billable
Hours,Burn Percentage,End Date,Planned Hours,Planned Hours Remaining,Project Health,Project
Phase,Project Stage,Start Date,Done Statement” />
        <design:attribute name=“projField4” label=“Project Field #4” datasource=“Billable
Hours,Burn Percentage,End Date,Planned Hours,Planned Hours Remaining,Project Health,Project
Phase,Project Stage,Start Date” />
</design:component>
```

The Gantt Chart Component 603 uses a customized version of the Chartjs Javascript library to render project tasks on a timeline. The Apex controller 32 queries the project tasks, with their start and end dates. The data is limited to tasks 56 in the context of the project, no more than 10 tasks, and tasks which are on the parent level. The queried data is passed into the component's controller 20, which is processed by the helper 22. The helper 22 gathers each iteration of the task 56 and loops through to place it on the chart. The tasks are ordered by start date, with the first date at the top. In addition to the queried data, the helper 22 sets today's date with different styling. That is plotted on the chart with a line so that the user can see the project tasks in relation to the current date.

Exemplary coding for Gnatt component 603 controller 32 is as follows:

Apex Controller Code

```
public with sharing class projectGanttController {
    @AuraEnabled
    public static List<pse_Project_Task_c> getProjectTasks(Id
    projectId) {
      List<pse_Project_Task_c> projTasks = [
        SELECT Name, pse_End_Date_c,
        pse_Start_Date_c,
          pse_Percent_Complete_Hours_c FROM
        pse_Project_Task_c
        WHERE pse_Project_c=:projectId AND
        pse_Parent_Task_c = null
        ORDER BY pse_Start_Date_c ASC
        LIMIT 10];
      return projTasks;
      }
}
```

Exemplary coding for Gnatt component 603 is as follows:

Component Code

```
<aura:component controller=“projectGanttController”
implements=“flexipage:availableForAllPageTypes,
flexipage:availableForRecordHome,force:hasRecord
Id,forceCommunity:availableForAllPageTypes” access=“global”>
                <ltng:require scripts=“{!$Resource.ChartJS}”
afterScriptsLoaded=“{!c.afterScriptsLoaded}”/>
        <aura:attribute name=“recordId” type=“String” />
        <aura:attribute name=“ready” type=“Boolean” default=“false”/>
        <div class=“slds-box” style=“background:#ffffff;”>
                <canvas aura:id=“chart”></canvas>
        </div>
</aura:component>
```

Exemplary coding for Gnatt component 603 helper 22 is as follows:

Component Helper Code

```
({
      createChart : function (component) {
            var ready = component.get(“v.ready”);
            if (ready === false) {
                  return;
            }
            var chartCanvas = component.find(“chart”).getElement( );
            var action = component.get(“c.getProjectTasks”);
            action.setParams({
                  projectId : component.get(“v.recordId”)
            });
            action.setCallback(this, function(response) {
                  var state = response.getState( );
                  if (state === “SUCCESS”) {
                        var reportResultData = response.getReturnValue( );
                        console.log(“Controller Returns: ” + reportResultData); var
                        chartLabels = [ ];
                        var chartDatasetsArray = [ ]; var todayTime = new Date( ); var
                        hourPlus = 4;
                        var todayPlus = new Date( );
                        todayPlus.setHours(todayPlus.getHours( ) + 3)
                        var chartToday = {
                              pointBackgroundColor: “#c63431”,
                              pointBorderColor: “rgba(255,255,255,0)”,
                              backgroundColor: “#c63431”,
                              borderColor: “#c63431”,
                              borderWidth: 30,
                              pointStyle: ‘rectRot’,
                              pointRadius: ‘10’,
                              data: [
                                    {
                                      x: todayTime,
                                      y: “Project Management”
                                    }, {
                                      x: todayPlus,
                                      y: “Project Management”
                                    }
                              ]
                            };
                        var chartColors =
[“#11305d”,“#009edf”,“#6fdbd9”,“#00a599”,“#e2ce74”,“#e39f00”,“#c63431”,“#fbb84d”,“#5bb078”,“#
7 2c156”];
                        for(var i=0; i < (reportResultData.length); i++) {
                              var labelTemp = reportResultData[i].Name;
                              chartLabels.push(labelTemp);
                              chartDatasetsArray[i] =
                                {
                                  pointBackgroundColor: chartColors[i],
                                  pointBorderColor: “rgba(255,255,255,0)”,
                                  backgroundColor: “rgba(255,255,255,0)”,
                                  borderColor: chartColors[i], borderWidth: 30,
                                  pointRadius: 15,
                                  pointBorderWidth: 0,
                                  data: [
                                        {
                                          x: new
Date(reportResultData[i].pse_Start_Date_c),
                                          y: chartLabels[i]
                                        },{
                                          x: new
Date(reportResultData[i].pse_End_Date_c),
                                          y: chartLabels[i]
                                        }
                                    ]
                                  }
            }
            chartDatasetsArray.unshift(chartToday);
            //chartLabels.push(“Today”);
            console.log(todayTime);
            console.log(todayPlus);
            console.log(chartDatasetsArray);
            //Construct chart
            var chart = new Chart(chartCanvas,{
                  type: ‘line’,
                  data: {
                        datasets: chartDatasetsArray,
                  },
                  options: {
                        legend: {
                              display: false
                        },
                        tooltips: {
                              enabled: false
                        },
                        hover: {
                            mode: null
                        },
                        scales: {
                            xAxes: [{
                        type: ‘time’,
                        offset: true,
                        time: {
                              unit: ‘week’,
                              displayFormats: {
                                    week: “MMMM D”,
                                    month: “MMMM” + “ ‘” + “YY”
                              }
                        },
                        distribution: ‘linear’,
                        position: ‘top’,
                        ticks: {
                        fontSize: 13,
                        fontFamily: “‘Salesforce Sans’,Arial,sans-serif”,
                        }
                      }],
                      yAxes: [{
                        type: ‘category’,
                        labels: chartLabels,
                        offset: true,
                        gridLines: {
                              display: false,
                        },
                        ticks: {
                              fontFamily: “‘Salesforce Sans’,Arial,sans-
                                    serif”,
                        }
                      }]
                    }
                  }
              });
            } else if (state === “ERROR”) {
              var errors = response.getError( );
              if (errors) {
                if (errors[0] && errors[0].message) {
                console.log(“Error message on createReport: ” +
                        errors[0].message);
              }
          } else {
                console.log(“Unknown error”);
          }
          }
      });
      $A.enqueueAction(action);
    }
})
```

The Report Component 602 queries and sums the estimated and burned hours from the project tasks 56. High-volume portal 100 users 12 typically do not have the ability to run reports, so a custom component 602 was built to show the report. The Apex controller 32 queries the project tasks 56 associated with the contextual project. The query grabs parent level tasks, sums the estimated and actual hours and pushes them into a list. The output data from the controller 32 is passed from the component's controller 20 into the helper 22, which runs on load. The helper 22 leverages the chart.js library to build the chart. The two summed values are plotted as bars related to the parent level task.

Exemplary coding for report component 602 apex controller 32 is as follows:

Apex Controller Code

```
public with sharing class projectTaskController {
      @AuraEnabled
      public static List<AggregateResult> getProjectTasks(Id
      projectId) {
            List<AggregateResult> projTasks = [SELECT
pse_Parent_Task_r.Name, SUM(pse_Estimated_Hours_c)
estSum, SUM(pse_Actual_Hours_c) actSum
            FROM pse_Project_Task_c WHERE
pse_Project_c=:projectId AND pse_Parent_Task_c <> null
GROUP BY pse_Parent_Task_r.Name];
            return projTasks;
            }
}
```

Exemplary coding for report component 602 is as follows:

Component Code

```
<aura:component controller=“projectTaskController”
implements=“flexipage:availableForAllPageTypes,
flexipage:availableForRecordHome,force:hasRecord
Id,forceCommunity:availableForAllPageTypes” access=“global”>
                <ltng:require scripts=“{!$Resource.ChartJS}”
afterScriptsLoaded=“{!c.afterScriptsLoaded}”/>
        <aura:attribute name=“recordId” type=“String” />
        <aura:attribute name=“ready” type=“Boolean” default=“false”/>
        <div class=“slds-box” style=“background:#ffffff;”>
            <canvas aura:id=“chart”></canvas>
        </div>
</aura:component>
```

Exemplary coding for report component 602 controller 20 is as follows:

Component Controller Code

```
({
        afterScriptsLoaded : function(component, event, helper) {
                component.set(“v.ready”, true);
                helper.createChart(component);
        }
})
```

Exemplary coding for report component 602 helper 22 is as follows:

Component Helper Code

```
({
        createChart : function (component) {
                var ready = component.get(“v.ready”);
        if (ready === false) {
                return;
        }
        var chartCanvas = component.find(“chart”).getElement( );
        var action = component.get(“c.getProjectTasks”);
        action.setParams({
                projectId : component.get(“v.recordId”)
        });
        action.setCallback(this, function (response) {
                var state = response.getState( );
                if (state === “SUCCESS”) {
                        var reportResultData = response.getReturnValue( );
                        console.log(“Controller Returns: ” + reportResultData);
                        var chartDataSeries1 = [ ];
                        var chartDataSeries2 = [ ];
                        var chartLabels = [ ];
                        for(var i=0; i < (reportResultData.length); i++){
                                var labelTemp = reportResultData[i].Name;
                                chartLabels.push(labelTemp);
                                var estTemp = reportResultData[i].estSum;
                                chartDataSeries1.push(estTemp);
                                var actTemp = reportResultData[i].actSum;
                                chartDataSeries2.push(actTemp);
                        }
                        console.log(“Series1 Returns: ” + chartDataSeries1)
                        console.log(“Series2 Returns: ” + chartDataSeries2)
                        //Construct chart
                        var chart = new Chart(chartCanvas,{
                                type: ‘bar’,
                                data: {
                                        labels: chartLabels,
                                        datasets: [
                                        {
                                                label: “Estimated Hours”,
                                                data: chartDataSeries1,
                                                backgroundColor: “#1aa2dd”
                                          }, {
                                                label: “Consumed Hours”,
                                                data: chartDataSeries2,
                                                backgroundColor: “#18335b”
                                          }
                                    ]
                            },
                            options: {
                                legend: {
                                    position: ‘bottom’,
                                    padding: 10,
                                    labels: {
                                      boxWidth: 15,
                                      fontFamily: “‘Salesforce Sans’,Arial,sans-
                                          serif”,
                                    },
                                },
                                scales: {
                                    yAxes: [{
                                          ticks: {
                                            fontColor: ‘#DDD’,
                                            fontFamily: “‘Salesforce
                                                Sans’,Arial,sans-serif”,
                                          }
                                    }],
                                    xAxes: [{
                                        gridLines: {
                                            display: false,
                                        },
                                        ticks: {
                                            fontFamily: “‘Salesforce
                                                Sans’,Arial,sans-serif”,
                                                    autoSkip: false
                                                }
                                            }],
                                        },
                                        responsive: true,
                                    }
                            });
                        } else if (state === “ERROR”) {
                            var errors = response.getError( );
                            if (errors) {
                                if (errors[0] && errors[0].message) {
                                    console.log(“Error message on createReport: ” +
                                                        errors[0].message);
                                }
                            } else {
                                console.log(“Unknown error”);
                            }
                        }
                });
                $A.enqueueAction(action);
        }
})
```

The Project Team Component 606 queries the user 12 records for the Project Manager 78 and the Account Executive 80 associated to the project. Embodiments of this component 606 will query additional project team members to give clients a more personal experience. Project team component 606 displays the queried data with project roles displayed above the user. The user's 12 chatter profile image on the left, the user's name, title and biography on the right. Using an <aura:if> tag, it will not render additional team members if their record isn't found.

Exemplary coding for the project team component 606 apex controller 32 is as follows:

Apex Controller Code

```
    public with sharing class projectTeamController {
        @AuraEnabled
        public static List<pse_Proj_c> getTeamData(Id projectId) {
            list<pse_Proj_c> lstProj = [SELECT Name,
                              Project_Manager_UserR_r.Name,
                              Project_Manager_UserR_r.
                              AboutMe,
                              Project_Manager_UserR_r.Title,
                              Project_Manager_UserR_r.
                              MediumPhotoUrl,
                              pse_Opportunity_Owner_r.Name,
                              pse_Opportunity_Owner_r.
                              AboutMe,
                              pse_Opportunity_Owner_r.Title,
                              pse_Opportunity_Owner.
                              MediumPhotoUrl
            FROM pse_Proj_c WHERE Id=:projectId];
        system.debug(lstProj);
        return lstProj;
    }
}
```

Exemplary coding for the project team component 606 is as follows:

Component Code

```
<aura:component controller=“projectTeamController”
implements=“flexipage:availableForAllPageTypes,flexipage:availableForRecordHome,force:hasRecord
Id,forceCommunity:availableForAllPageTypes” access=“global”>
        <aura:attribute name=“recordId” type=“String” />
        <aura:attribute name=“ready” type=“Boolean” default=“false”/>
        <aura:handler name=“init” value=“{!this}” action=“{!c.doInit}” />
        <aura:attribute name=“team” type=“pse_Proj_c[ ]” />
                <aura:iteration items=“{!v.team}” var=“teamMember”>
                    <h2 class=“slds-text-heading_small slds-page-header slds-text-title_caps”
style=“margin-top:2rem;”>Your Project Manager</h2>
                    <div class=“slds-grid slds-gutters” style=“margin-top:1rem;”>
                        <div class=“slds-col slds-size_1-of-4” style=“display:inline-block;
text-align:right;”>
                            <div class=“photoWrapper thePhoto xLargeSize”>
                                <div class=“entityPhotoSpecificity xLargeSize circular
forceChatterEntityPhoto” style=“background-color: #ffffff;”>
                                    <span class=“uiImage”>
                                        <img
src=“{!teamMember.Project_Manager_UserR_r.MediumPhotoUrl}” class=“image” alt=“” title=“” />
                                    </span>
                                </div>
                            </div>
                    </div>
                    <div class=“slds-col slds-size_3-of-4 slds-grid--vertical-align-center”
style=“display:inline-block; padding:2rem 5rem 0 1rem;”>
                        <h2
class=“slds-text-heading_large”>{!teamMember.Project_Manager_UserR_r.Name}</h2>
                        <p
class=“slds-text-title_caps”>{!teamMember.Project_Manager_UserR_r.Title}</p>
                        <p class=“slds-text-longform”
style=“padding-top:15px”>{!teamMember.Project_Manager_UserR_r.AboutMe}</p>
                    </div>
                </div>
                <aura:if isTrue=“{!not(empty(teamMember.pse_Opportunity_Owner_r.Name))}”>
                <h2 class=“slds-text-heading_small slds-page-header slds-text-title_caps”
style=“margin-top:2rem;”>Your Account Executive</h2>
                <div class=“slds-grid slds-gutters” style=“margin-top:1rem;”>
                    <div class=“slds-col slds-size_1-of-4” style=“display:inline-block;
text-align:right;”>
                        <div class=“photoWrapper thePhoto xLargeSize”>
                            <div class=“entityPhotoSpecificity xLargeSize circular
forceChatterEntityPhoto” style=“background-color: #ffffff;”>
                                <span class=“uiImage”>
                                    <img
src=“{!teamMember.pse_Opportunity_Owner_r.MediumPhotoUrl}” class=“image” alt=“” title=“” />
                                </span>
                            </div>
                        </div>
                    </div>
                    <div class=“slds-col slds-size_3-of-4 slds-grid--vertical-align-center”
style=“display:inline-block; padding:2rem 5rem 0 1rem;”>
                        <h2
class=“slds-text-heading_large”>{!teamMember.pse_Opportunity_Owner_r.Name}</h2>
                        <p
class=“slds-text-title_caps”>{!teamMember.pse_Opportunity_Owner_r.Title}</p>
                        <p class=“slds-text-longform”
style=“padding-top:15px”>{!teamMember.pse_Opportunity_Owner_r.AboutMe}</p>
                    </div>
                </div>
                </aura:if>
            </aura:iteration>
</aura:component>
```

Exemplary coding for the project team component 606 controller 20 is as follows:

Component Controller Code

```
({
    doInit : function(component, event) {
        var action = component.get(“c.getTeamData”);
        action.setParams({
            projectId : component.get(“v.recordId”)
        });
        action.setCallback(this, function (response) {
            var state = response.getState( );
            if (state === “SUCCESS”) {
                var respObj = component.get(“v.team”);
                respObj.push(response.getReturnValue( ));
                var listTeam = component.get(“v.team”);
                for (var i = 0; i < listTeam.length; i++) {
                    component.set(“v.team”, listTeam[i]);
                }
                console.log(listTeam);
                console.log(respObj);
            }
        });
        $A.enqueueAction(action);
    }
})
```

Although various embodiments have been shown and described, the present disclosure is not so limited and will be understood to include all such modifications and variations are would be apparent to one skilled in the art.

What is claimed is:

1. A portal interface system, displayable on a computing device, the portal interface system communicating with data related to a project managed with a Customer Relationship Management (CRM) program, the portal interface system comprising:
a protection component that controls access to the portal interface to only authorized users;
a link to at least one project page, the project page further comprising:
at least one tab containing the data related to the project managed with a CRM program; and
a metrics component display area that displays metrics component processed results of the data related to the project;
and wherein the metrics component processed results comprise one or more of: a project done statement display, a project phase display, a project health display, a burn percentage display, a project hours display, a project budget display, a project tasks display, a project complete percentage display, a target go-live date display, and an end date display.

2. The portal interface system of claim 1 further comprising:
a Kanban board component display area that displays Kanban component processed results of the data related to the project;
and wherein the Kanban component processed results comprise one or more of: RAID (Risks, Actions, Issues and Decisions) log entries, project phases, project tasks, and project progress.

3. The portal interface system of claim 2 wherein the Kanban component processed results comprise RAID log entries and the RAID log entries are grouped by status.

4. The portal interface system of claim 1 further comprising:
a second link to a second project page, the second project page further comprising:
at least one tab containing the data related to the project managed with a CRM program; and
a metrics component display area that displays metrics component processed results of the data related to the project;
and wherein the metrics component processed results comprise one or more of: project planned hours, project consumed hours, and project hours remaining.

5. The portal interface system of claim 4 further comprising:
a report component display area that displays report component processed results of the data related to the project;
and wherein the report component processed results comprise parent level tasks.

6. The portal interface system of claim 5 wherein the parent level tasks are summed by estimated and consumed hours.

7. The portal interface system of claim 4 further comprising:
a Gantt component display area that displays Gantt component processed results of the data related to the project;
and wherein the Gantt component processed results comprise parent level tasks ordered by start date.

8. The portal interface system of claim 4 further comprising:
a Kanban board component display area that displays Kanban board component processed results of the data related to the project;
and wherein the Kanban component processed results comprise project tasks grouped by status.

9. The portal interface system of claim 1 further comprising:
a second link to a second project page, the second project page further comprising:
a chatter feed component display area that displays chatter feed component processed results;
and wherein the chatter feed component processed results comprise one or more of: external and internal communication platforms.

10. The portal interface system of claim 1 further comprising:
a second link to a second project page, the second project page further comprising:
a project details display area that displays fields associated with a project object.

11. The portal interface system of claim 10 wherein the fields associated with a project object include links to a cloud-based storage repository.

12. The portal interface system of claim 1 further comprising:
a second link to a second project page, the second project page further comprising:
a project documents display area that displays documents associated with a project.

13. The portal interface system of claim 12 wherein the project documents display area is configured to enable uploading and downloading of the documents associated with a project.

14. The portal interface system of claim 1 further comprising:
a second link to a second project page, the second project page further comprising:
a project team component display area that displays project team component processed results;
and wherein the project team component processed results comprise one or more of: a project account executive, a project delivery manager, and a project manager.

15. The portal interface system of claim 14 wherein the project team component processed results further comprise a profile image.

16. A method for displaying a portal interface system on a computing device, the portal interface system communicating with data related to a project managed with a Customer Relationship Management (CRM) program, the method comprising:
controlling access to the portal interface system with a protection component that controls access to the portal interface to only authorized users;
linking to at least one project page, the project page further comprising:
at least one tab containing the data related to the project managed with a CRM program; and
a metrics component display area that displays metrics component processed results of the data related to the project;
and wherein the metrics component processed results comprise one or more of: a project done statement display, a project phase display, a project health display, a burn percentage display, a project hours display, a project budget display, a project tasks display, a project complete percentage display, a target go-live date display, and an end date display.

17. The method of claim 16 further comprising:
displaying a Kanban board component display area that displays Kanban component processed results of the data related to the project;
and wherein the Kanban component processed results comprise one or more of: RAID (Risks, Actions, Issues and Decisions) log entries, project phases, project tasks, and project progress.

18. The method of claim 16 further comprising:
linking to a second project page, the second project page further comprising:
at least one tab containing the data related to the project managed with a CRM program; and
a metrics component display area that displays metrics component processed results of the data related to the project;
and wherein the metrics component processed results comprise one or more of: project planned hours, project consumed hours, and project hours remaining.

19. The method of claim 18 further comprising:
displaying a report component display area that displays report component processed results of the data related to the project;
and wherein the report component processed results comprise parent level tasks.

20. The method of claim 18 further comprising:
displaying a Gantt component display area that displays Gantt component processed results of the data related to the project;
and wherein the Gantt component processed results comprise parent level tasks ordered by start date.
